(19) United States
(12) Patent Application Publication
(10) Pub. No.: US 2020/0158206 A1
(43) Pub. Date: May 21, 2020

(54) LOW FRICTION CABLE PROTECTOR CLAMP

(71) Applicant: WWT North America Holdings, Inc., Houston, TX (US)

(72) Inventor: Sarah Banks, Fullerton, CA (US)

(21) Appl. No.: 16/665,979

(22) Filed: Oct. 28, 2019

Related U.S. Application Data
(60) Provisional application No. 62/769,203, filed on Nov. 19, 2018.

(51) Int. Cl. F16G 11/10; F16G 11/04

(52) U.S. Cl. CPC F16G 11/108; F16G 11/04

(57) ABSTRACT

A cable clamp for attaching a cable or tubing to a tubular drill casing string comprising an at least one-piece low friction polymer clamp having an interior surface geometry matching an exterior geometry of the casing string and cable, and an exterior surface geometry which is larger than the largest outside profile of the casing string and the cable or tubing so that the exterior surface of the clamp carries at least some of the contact load between the casing string and the wellbore. The clamp has a low friction exterior surface to reduce sliding friction between the clamp and the wellbore during drilling and a high-friction interior surface to grip the casing string and reduce slippage between the clamp and the casing string, and can be hinged and include a band for securing the clamp to the casing string.

### CROSS-REFERENCE TO RELATED APPLICATIONS

This application claims priority to and the benefit of U.S. Provisional Patent Application No. 62/769,203, filed Nov. 19, 2018, the entire contents thereof are incorporated herein by reference.

### BACKGROUND

When completing construction of oil and gas wells, it is often necessary to run electrical cable or small diameter tubing (herein called ‘cable’) along the outside of production tubing or casing (herein called ‘casing’). Examples of smaller diameter cable and tubing uses include electrical cable to power electric submersible pumps and valves, data cable to convey information from downhole sensors, and nitrogen and gas lift tubing to help with production in low pressure reservoirs. Existing cable and tubing clamps, which are bands, are normally used to secure the cable or small diameter tubing to the pipe and are made from stamped steel, shaped to wrap around the casing and the cable.

Most wells being drilled are horizontal wells. This means that due to buckling limitations, tubing and casing with external cable can only be run so far into the high angle or horizontal portion of the well. Also, the tubing or casing cannot be rotated without running the risk of damaging the cable attached thereto or tearing off the clamps leaving debris in the wellbore.

Reducing the overall friction between the wellbore and the casing string greatly increases the depth or distance that the casing string can be run into the well before drag and buckling results in what is called ‘lock-up’. Existing clamps do not contribute to reducing friction.

Consequently a need exists for cable clamp that addresses the problems associated with existing clamps which protects the cable and contributes to reducing friction between the wellbore and the casing string.

### SUMMARY OF THE INVENTION

The present invention is directed to a clamp for attachment to a tubular steel casing string for attaching an electrical power cable, data cable, or gas injection tubing, which reduces the coefficient of friction for the drill string in the wellbore to enable running into horizontal or high-inclination angle wellbores. The clamp can be a two-piece piece construction which can be banded or hinged. The clamp is made from a low friction polymer material. The clamp has an interior geometry that matches the exterior geometry of the casing and cable. The exterior geometry is larger than the largest outside profile of the casing string so that the clamp carries some or all of the contact loads between the casing string and the wellbore.

### BRIEF DESCRIPTION OF THE DRAWINGS

FIG. 1 is a perspective view of a first embodiment low friction cable protector clamp of the present invention;

FIG. 2 is a perspective view of an alternative embodiment low friction cable protector clamp;

FIG. 3 is a perspective view of the clamp of FIG. 1 as installed;

FIG. 4 is a perspective view of another alternative embodiment low friction cable protector clamp as installed of the present invention; and

FIG. 5 is a perspective view of another alternative embodiment single piece cable protector clamp.

### DETAILED DESCRIPTION

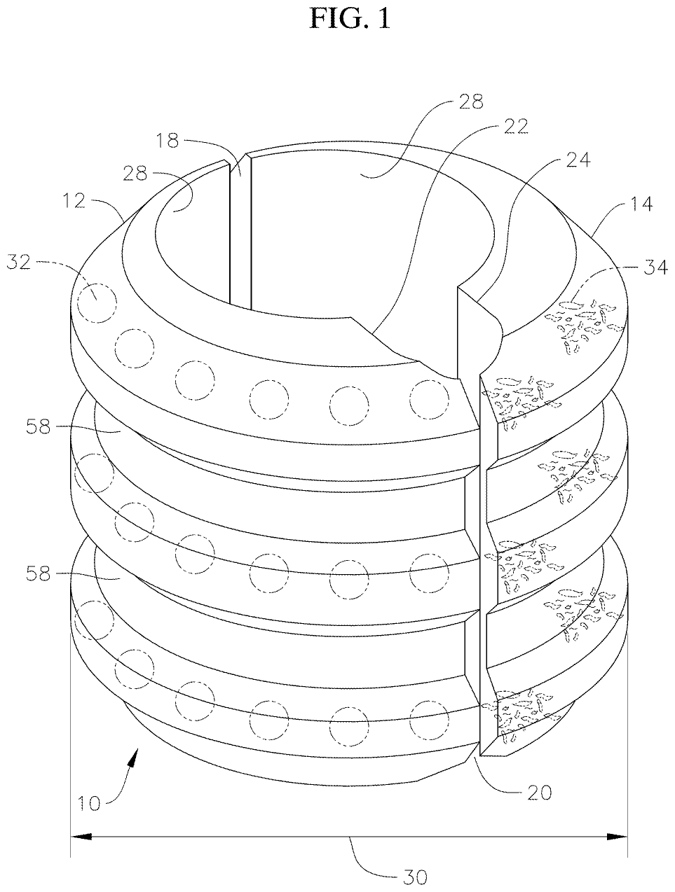

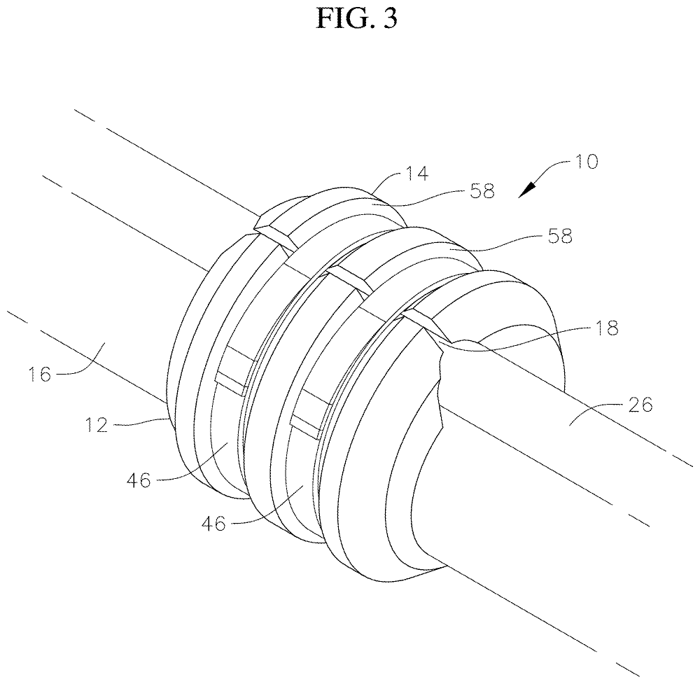

Referring to FIG. 1, a low friction cable protector clamp 10 of the present invention is illustrated. The clamp comprises two sections 12 and 14 which are substantially semi-circular in construction for attachment to a tubular steel casing string 16 as illustrated in FIG. 3. These sections are positioned around the tubular steel casing string such that gaps 18 and 20 are positioned on opposite sides of the casing string. Each of the first and second sections 12, 14 have a cutout portion 22 and 24 for receipt of an electrical power cable, data cable or gas injection tube, collectively referred to herein as a cable 26, that extends along the length of the tubular steel casing string 16. The clamp 10 holds the cable 26 in place along the casing string 16 and prevents it from damage as will be discussed in further detail herein. The interior geometry 28 of each of the first and second sections 12, 14 of clamp 10 matches the exterior geometry of the tubular steel casing string 16 and cable 26. The exterior geometry or diameter 30 of the clamp when installed is larger than the largest outside profile of the casing string so that the clamp carries some or all of the contact loads between the casing string and the wellbore. In one embodiment, the clamp 10 is made from a low friction polymer material.

In alternative embodiments, the clamp can be made from ultra-high molecular weight polyethylene (UHMW-PE); low friction thermoplastic materials including polyamide (PA, nylon), acetal (POM, polyoxymethylene), polyphenylene sulfide (PPS), polyphthalamide (PPA), epoxy, or polyester based alone or with functional fluoropolymer materials such as PFA, FEP, ETFE, ECTFE, or other friction reducing fillers such as graphite or molybdenum disulfide may be used. Polyetherimide (PEI) and polyetheretherketon (PEEK) materials can also be used for high temperature applications.

Ideally, the low friction clamp exterior surface will be wear resistant and have a coefficient of friction that is 50% or less than the coefficient of friction of the steel casing against the wellbore. The material must also be resistant to degradation in water and oilbased wellbore fluids, including completion brine solutions.

In an embodiment where UHMW-PE material is used as the primary component, it offers low friction and high wear resistance at temperatures less than 230° F. The UHMW-PE may also be filled with materials such as glass spheres 32 or fibers 34 to augment the strength, heat deflection temperature, or wear resistance of the base material. At higher temperatures, combinations of fluorocarbons and other thermoset or thermoplastic materials would be utilized.

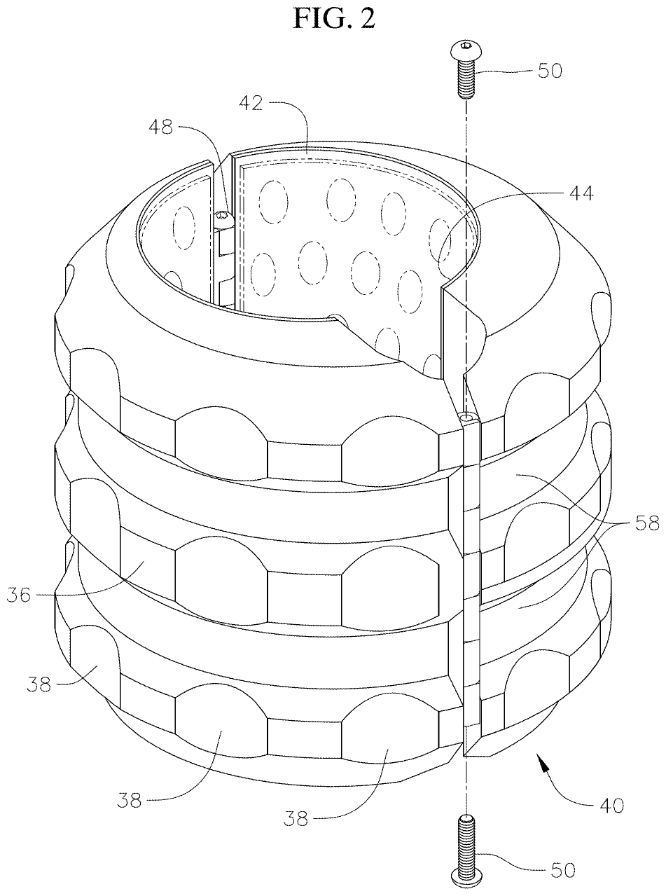

Referring also to FIG. 2, the exterior surface 36 is cylindrical to help centralize the casing and cable within the wellbore. The exterior surface 36 may also be molded with vertical grooves 38 to allow fluid to easily flow around the clamp 40 without restriction.

The inner surface 42 of the clamp may be co-molded with a thin layer 44 of elastomeric material such as rubber, or particles of rubber, or another high-friction material (such as sand particles or polyurethane) to increase the gripping force and prevent slippage of the clamp on the casing.

Another embodiment also includes manufacturing the low friction and high friction components separately, to allow for one outer low friction ‘shell’ to work with multiple high friction inserts to accommodate multiple configurations of cable and/or small diameter tubing.

As shown in FIG. 3, the clamp 10 is secured to the casing 16 and cable 26 by means of one or more crimped or bolted stainless steel or carbon steel bands 46. Other fastening methods may be used, such as a hinged internal cage 48, or bolts or strews 50 used to hold the two clamp halves together.

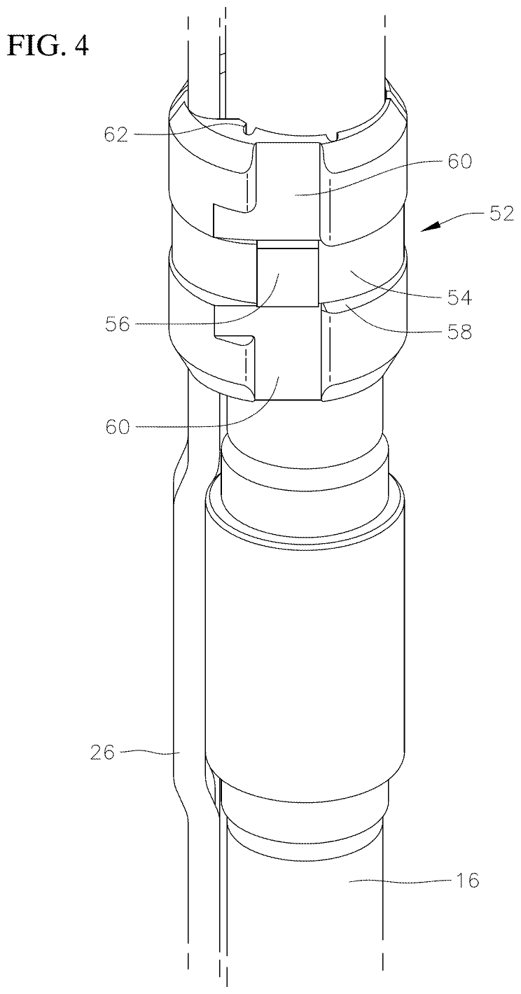

As shown in FIG. 4, clamp 52, uses one or more industry-standard flat metallic bands 54 commonly used to hold cable around production casing and tubing. These bands wrap through a buckle 56 that is crimped to hold the band in place. By adapting the low-friction cable protector clamp to use industry standard banding, it allows rig crews the option to use the same bands and same installation tooling to install the clamp as they might otherwise be using to hold the cable in place, saving rig time and money.

The clamp incorporates a circumferential slot or groove 58 that closely fits the metallic band. There is also a cutout portion 60 around the buckle to allow for installation tooling to crimp the band, and to allow flow of fluid and material around the clamp while inside the wellbore. This geometry allows the band and buckle to sit flush with the surface of the clamp, and to help protect the crimped band while the tubing is being run into and out of the well. The sloped smooth outer profile and protected band reduces the risk of losing bands downhole. This means a reduced risk of debris in the hole that can cause damage to pumps and other downhole equipment. The metallic bands also have the advantage of being easy to remove by cutting the band with shears if it becomes necessary to remove the production tubing from the well, as production tubing must be pulled occasionally to service the well. The clamp can also include a plurality of axial grooves 62 on the inner surface 42 to allow the passage of drilling fluid through the clamp.

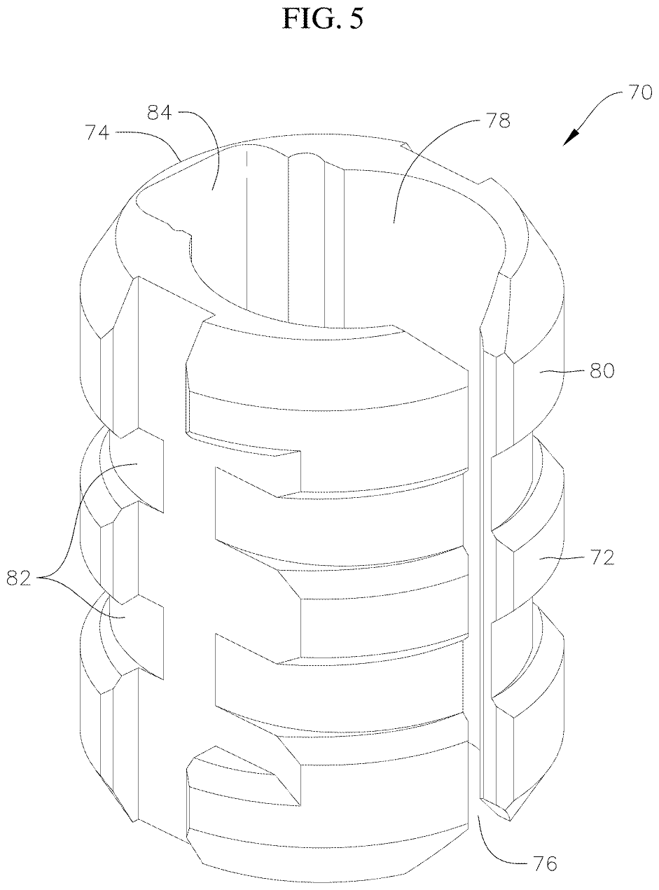

As shown in FIG. 5, an alternative embodiment clamp 70 is illustrated. Clamp 70 is a single piece cast body 72 having a molded hinge 74 opposite from a split section 76 allowing the clamp to flex open to be inserted around the tubular casing string 16. Hinge 74 has a thinner cross-section than the remaining portion of the clamp thereby allowing the clamp to flex open during installation. An advantage of this embodiment is the clamp stays as one piece for easier handling during installation and is less likely to fall down hole during installation. The clamp can be made as molded polyurethane, or as molded plastic with a rubber interior surface 78. The exterior surface 80 provides for a lower friction surface. For example, the clamp 70 can be a cast polyurethane having a lower friction durable hard urethane exterior and a higher friction softer urethane interior. The embodiment illustrated in FIG. 5 includes two circumferential grooves 82 for placement of a band for retaining the clamp in position on the casing string. Clamp 70 includes a cutout portion 84 for receipt of the cable or tubing.

Commercially available well torque and drag software may be used to determine the quantity of clamps required and the most effective placement within the wellbore to reduce overall drag. In general, in horizontal wellbores, the clamps will be most effective when installed lower in the well, particularly on any casing that is being run through the curve section of the well and out into the horizontal section of the well. In a typical application with a 5000 ft horizontal section, 50 to 150 of the low friction clamps would be adequate to provide enough friction reduction to enable fast, efficient running of casing to the bottom of the well.

Although the present invention has been disclosed with respect to various embodiments thereof, it is to be understood that changes and modifications can be made therein which are within the full intended scope of the invention as hereinafter claimed.

What is claimed is:

1. A device for attaching a cable or tubing to a wellbore tubular comprising one or more sections having an exterior low friction material and a high friction interior surface with a geometry that corresponds to an exterior surface of the attached cable or tubing, and an exterior band around the device.

2. The device of claim 1 wherein the device is a clamp and the exterior low friction material comprises an ultra-high molecular weight polyethene.

3. The device of claim 1 wherein the device is a clamp and the exterior low friction material comprises at least one of a polyamide, acetal, polyphenylene sulfide, polyphthalamide, epoxy, or polyester.

4. The device of claim 3 wherein the exterior low friction material further comprises a functional fluoropolymer.

5. The device of claim 3 wherein the exterior low friction material further comprises a friction reducing filler such as graphite or molybdenum disulfide.

6. The device of claim 2 wherein the exterior low friction material further comprises glass spheres or fibers.

7. The device of claim 1 wherein the device is a clamp and the exterior low friction material comprises combinations of fluorocarbons and thermoset or thermoplastic materials.

8. The device of claim 1 wherein an exterior surface geometry of the clamp is cylindrical.

9. The device of claim 8 wherein the cylindrical exterior surface geometry includes a plurality of axial grooves positioned around the exterior surface geometry.

10. The device of claim 1 further comprising a co-molded inner gripping layer positioned on the high friction interior surface.

11. The device of claim 10 wherein the inner gripping layer is a high friction material such as rubber, sand or polyurethane.

12. The device of claim 1 wherein the clamp includes at least one exterior circumferential groove for receipt of the band.

13. The device of claim 1 wherein the clamp includes an exterior cut-out portion to accommodate a band installation tool.

14. The device of claim 1 wherein the clamp includes a plurality of axial grooves on the high friction interior surface for passage of drilling fluid through the clamp.

15. A clamp for attaching a smaller diameter cable or tubing to a tubular casing string in a wellbore comprising a two piece polymer clamp having a low friction outer surface having a larger outside profile than the casing string and the attached cable or tubing and a high friction elastomeric interior surface with a geometry that corresponds to an exterior surface of the casing string and the attached cable or tubing.

16. The clamp of claim 15 wherein the clamp comprises at least one of an ultra-high molecular weight polyethene, a polyamide, acetal, polyphenylene sulfide, polyphthalamide, expoxy, polyester or function fluoropolymer.

17. The clamp of claim 16 further comprising at least one of a friction reducing filler, glass spheres or fibers.

18. The clamp of claim 15 wherein the interior surface includes a co-molded inner gripping layer of rubber, sand or polyurethane.

19. The clamp of claim 15 further comprising a band, a hinged internal cage or fasteners to secure the clamp to the tubular casing string.

20. The clamp of claim 19 wherein the clamp includes at least one exterior circumferential groove for receipt of the band.

21. A one piece clamp for attaching a smaller diameter cable or tubing to a tubular casing string in a wellbore having an integral hinge to allow flexing of the clamp during installation on the tubular casing string, the clamp having a hard exterior portion and a soft gripping interior portion to conform tightly around the cable or tubing.

22. The clamp of claim 21, wherein the hard exterior portion and the soft gripping interior portion are of plastic material of different hardnesses.

23. The clamp of claim 21, further comprising a band around the hard exterior portion for securing the clamp around the smaller diameter cable or tubing and the tubular casing string.
